(19) United States
(12) Patent Application Publication
(10) Pub. No.: US 2013/0280689 A1
(43) Pub. Date: Oct. 24, 2013

(54) Interactive Presentation System and Associated Methods

(71) Applicant: Via Response Technologies, LLC, Orlando, FL (US)

(72) Inventor: Derrick Meer, Orlando, FL (US)

(21) Appl. No.: 13/742,918

(22) Filed: Jan. 16, 2013

Related U.S. Application Data
(63) Continuation-in-part of application No. 13/334,993, filed on Dec. 22, 2011.
(60) Provisional application No. 61/586,955, filed on Jan. 16, 2012.

(51) Int. Cl. G09B 5/06

(52) U.S. Cl. CPC G09B 5/06
USPC 434/350

(57) ABSTRACT

A system and method are provided for presenting information to members of an audience and allowing interaction with a presenter. The presenter and members of the audience access network software as a service in a browser operable with a processor. Member devices are placed in signal communications with the processor through an Internet connection or an Intranet connection. The network software is accessed by the presenter using a presenter device and information presented to the members in the audience allowing a many-to-one communication and sharing of information.

### CROSS-REFERENCE TO RELATED APPLICATION

This application claims priority to U.S. Provisional Patent Application No. 61/586,955, having a filing date of Jan. 16, 2012 for Interactive Presentation System and Associated Methods and is a Continuation-in-Part of U.S. application Ser. No. 13/334,993, having a filing date of Dec. 22, 2011 for Educational Assessment System and Associated Methods which itself claims the benefit of U.S. Provisional Application No. 61/425,934, having filing date of Dec. 22, 2010 for Educational Assessment System and Associated Methods, the disclosures of which are hereby incorporated by reference herein in their entirety, and commonly owned.

### FIELD OF INVENTION

The present invention relates to systems and methods for interactive presentations, and more particularly to such systems and methods that employ audience activated responses.

### BACKGROUND

Audience response systems are known in the art for use in educational settings, and have been shown to increase attention and enhance learning. In some systems radio-frequency (RF) handheld devices, commonly known as “clickers,” are used by students to transmit answers to questions posed by the instructor. These answers are received by an instructor processor, which can process the answer data in a number of ways, including presenting graphical displays of the collected answer data to indicate class comprehension of the subject at hand.

It is well known to have audience members receiving Short Message Service (SMS) communications and responding back by SMS typically in a single modality and a one-to-many architecture. By way of example, a connection with a web browser (one) for a presenter (one) is able to receive and view questions from attendees via SMS that is then translated and forwarded to an instructor. However, there is typically no aggregation of correct responses only the response that is forwarded. The ability to render audience questions has no automation. Typically, known systems takes from thirty minutes to a couple of hours to sort, and manage incoming messages. Also, well known systems organize information data through a single code which allows for no grade book or organization or automatic tabulation of multiple sessions. Code is changed per discussion. In other words, typical systems are session based. There is a need to have organization defined by a term or period, by way of example, thus requiring a very different architecture with very different results as presented in embodiments of the invention herein described. Unlike that available in the art, there is a need to have a response return to a message initiator via text message, and a storing of the message. There is a need for an Internet Protocol (IP) based architecture with complete and automated logging and history. There is further a need for a system and method that utilizes native IP applications as well as IP based web applications that allow for local data storage until transport is available. Yet further, there is a need to have such storage and transport accomplished through an automation checking of availability of IP connections to a database, as is presented by embodiments of the invention herein described below.

Other systems are known in the art that employ “virtual clickers,” which are created by installing software on a student computing device such as a computer or mobile phone. Interaction is then mediated over the Internet between the student's device and the instructor processor.

Currently, all systems and designs are “many to one” allowing members of an audience, such as a student in a classroom environment to interact with one presenter, the teacher. Whether it is a hardware remote or native application, the delivery of the data is to a client/server application. This is an inherent limitation in current presentation systems.

The teachings of the present invention allow one to overcome such limitations by providing a “many-to-many” styled communications system and method. That is, the “many” within a classroom environment, whether real or virtual can now communicate with “many” others, whether they be other members of an audience or multiple presenters.

### SUMMARY

The present invention is directed to a system and method for improving group participation, such as in a classroom or lecture, and assessing effectiveness of a presentation.

A method aspect of the invention may comprise presenting information to members of an audience for allowing interaction with a presenter, wherein the presenter and members of the audience access network software as a service in a browser operable with a processor. Member devices are placed in signal communications with the processor through an Internet connection or an Intranet connection. The network software is accessed by the presenter using a presenter device. Information is presented to the members in the audience and communications with the presenter device is permitted for the members using the member devices.

A display may be provided on the presenter device. Members of the audience may select a presentation session to join, wherein questions may be transmitted to the members in the audience through the presenter device. A screen may be opened by at least a portion of the members of the audience on their individual member device, wherein each member is permitted to log in, and wherein a plurality of screens is made available on the displays as mediated by the presenter through the network software. The network software may be made available through a dedicated processor or through the network software as a service referred to as a “cloud” to those of skill in the art, herein referred to as a cloud processor.

The system may include software elements that are installable on a teacher processor and on a student communication device, which may comprise a computer or a mobile phone, by way of example.

The most fundamental change to current art is the change of core architecture presented by the present invention. Currently, all systems and designs are “many-to- one.” That is, an audience, such as a student class interacts with one presenter, the teacher. Whether it is a hardware remote or native application, the delivery of the data is to a client/server application. This inherent limitation is addressed by and is overcome by the teachings of the present invention. The present invention provides a “many to many” styled communications. That is, the “many” within a classroom environment, whether real or virtual can now communicate with “many” others, whether they be other members of an audience or multiple presenters. Yet further, multiple delivery modalities (e.g. IP and SMS) are made available.

With regard to a teaching environment, and as herein presented by way of example, more than just the instructor can view live data in classroom. Many instructors across many classrooms can view the same data coming in from many classrooms with a voting device of any type. The plurality of screens allow for the same question to be presented in multiple classrooms while multiple instructors review. The plurality of screens allows the instructor or instructors to see the data of the students at individually identifiable view that is impossible in single presentation systems. The “many-to-many” architecture furthers the present invention through personalization and self-service for the student. The devices become irrelevant because information transfer is tied to a name, a person, instead of hardware, such as a clicker and clicker number. The C#, HTML5, Java and objective C clients provide for legacy clickers to participate in the benefits of a many-to-many architecture as herein presented.

Presenter and audience member interfaces, such as a teacher and student interfaces, may be provided for composing, posing, and answering questions, participating in a class blog, and receiving real-time data on class comprehension of student learning objectives.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1A is a diagrammatical illustration of one presentation system in keeping with the teachings of the present invention;

FIG. 1B and 1C are diagrammatical illustrations of associated hardware and functionality for communications and system management, respectively, of the presentation system of FIG. 1A;

FIGS. 2A and 2B are flowcharts of an exemplary method of the present invention;

FIG. 3 is a diagrammatical illustration of an exemplary system of the present invention;

FIGS. 4 and 5 are exemplary teacher interface presentations, wherein as in FIG. 6, the instructor login allows instructors to have all data cloud based instead of on an individual hard drive;

FIGS. 6-9 illustrate, by way of example, screen shots used during presentation and response assessment; and

FIG. 10 is an exemplary student login interface and screen shot for one system according to the teachings of the present invention.

### DETAILED DESCRIPTION OF EMBODIMENTS

Embodiments of the invention will now be described more fully hereinafter with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art.

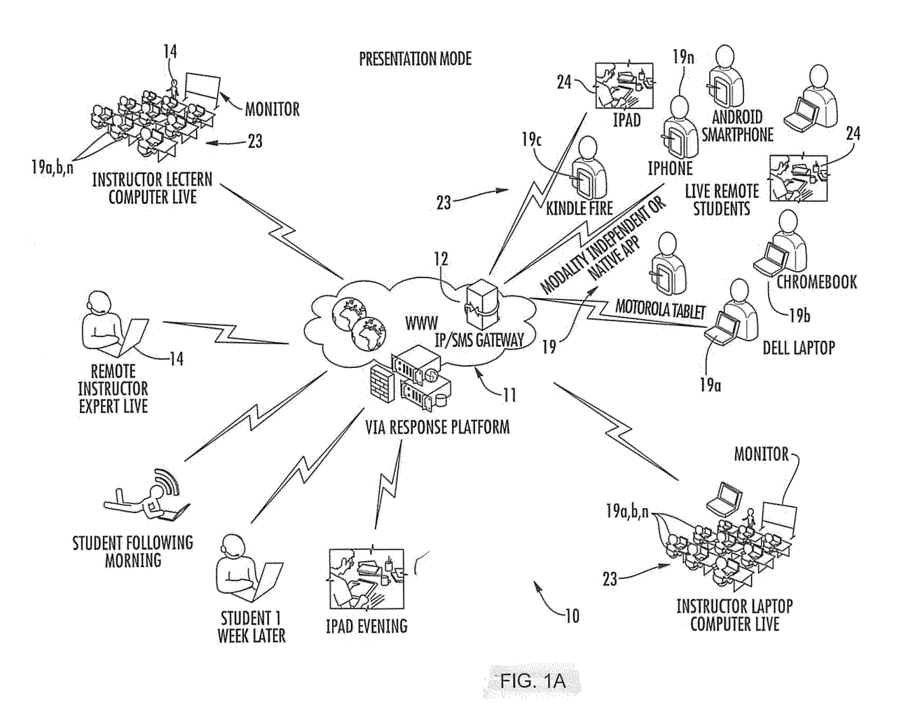

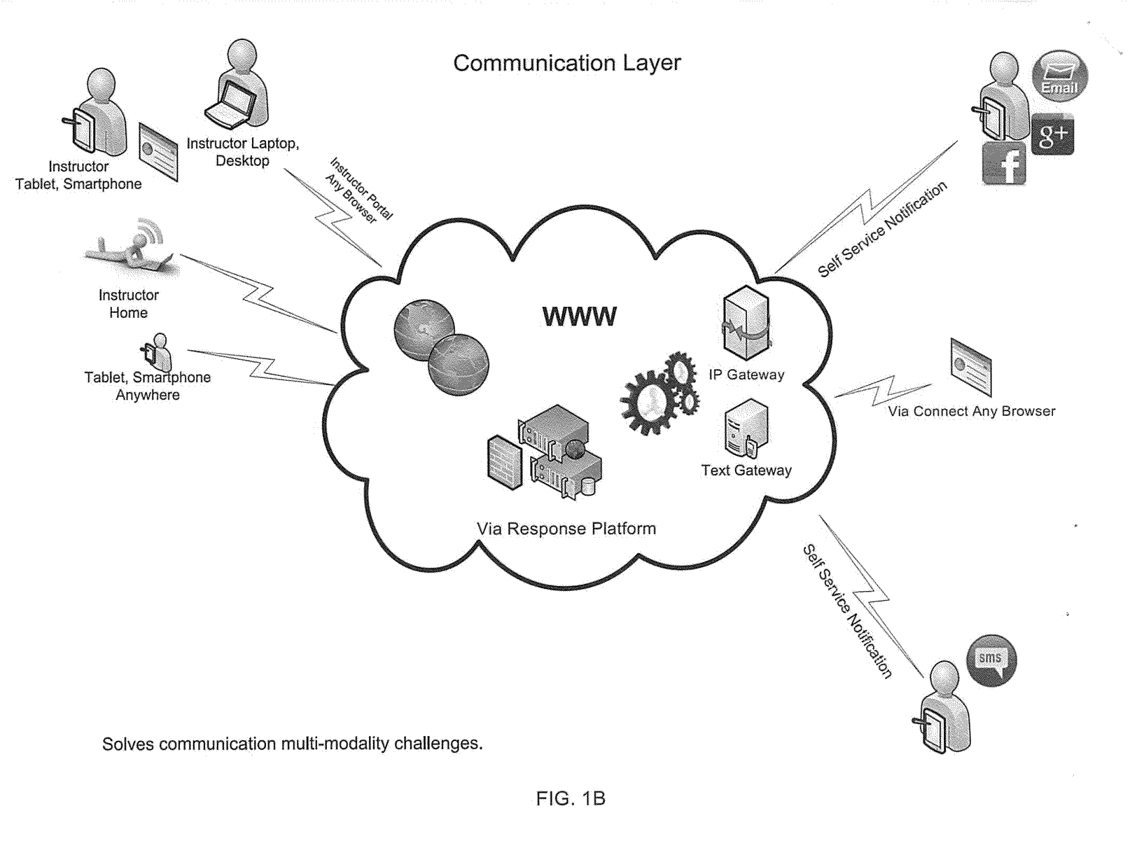

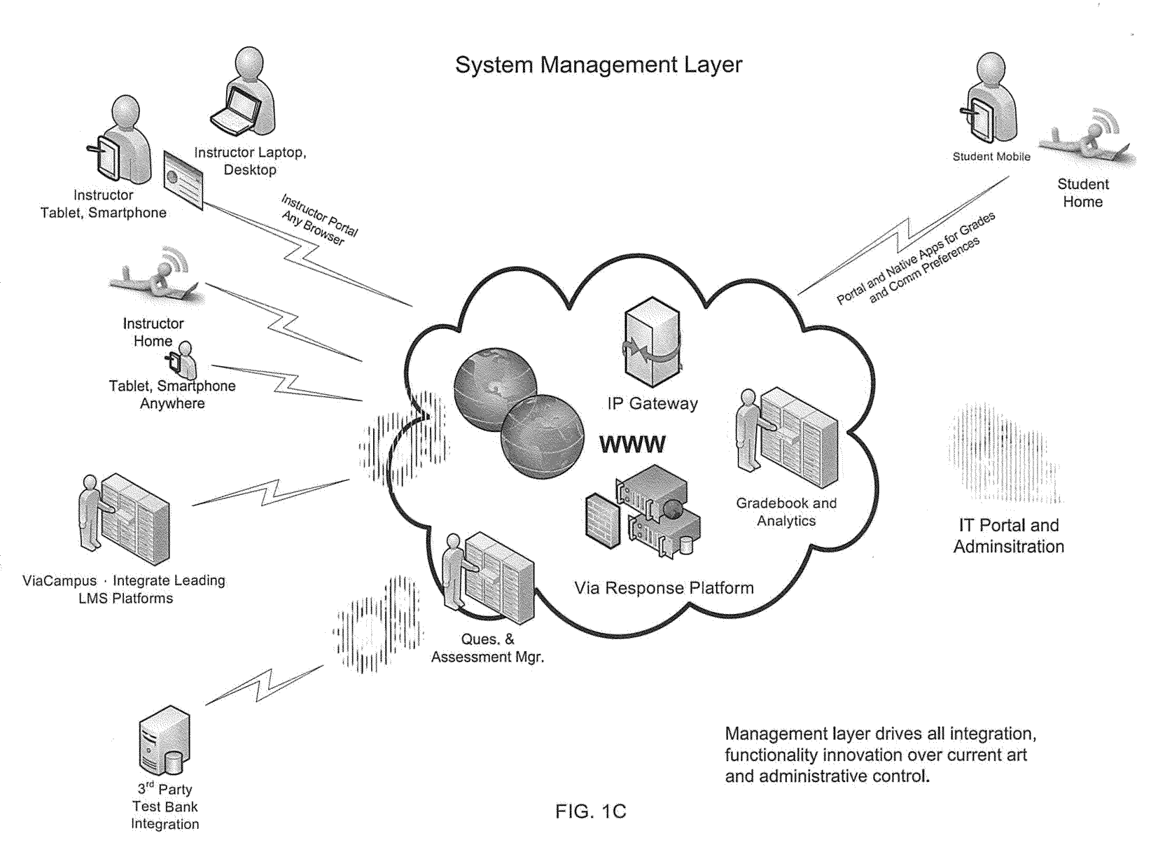

With reference initially to FIG. 1A, embodiment of the invention provide a system 10 that permits a member of an audience, such as students herein described by way of example, to interact with a presenter or multiple presenters, herein described as a teacher by way of example, in an organizational environment, such as a dedicated classroom or as remotely connected participants, by accessing network software 11 as a service in a browser or native application operable with a processor 12. As is understood by those skilled in the art, a browser includes software application for retrieving and presenting information resources on the World Wide Web.

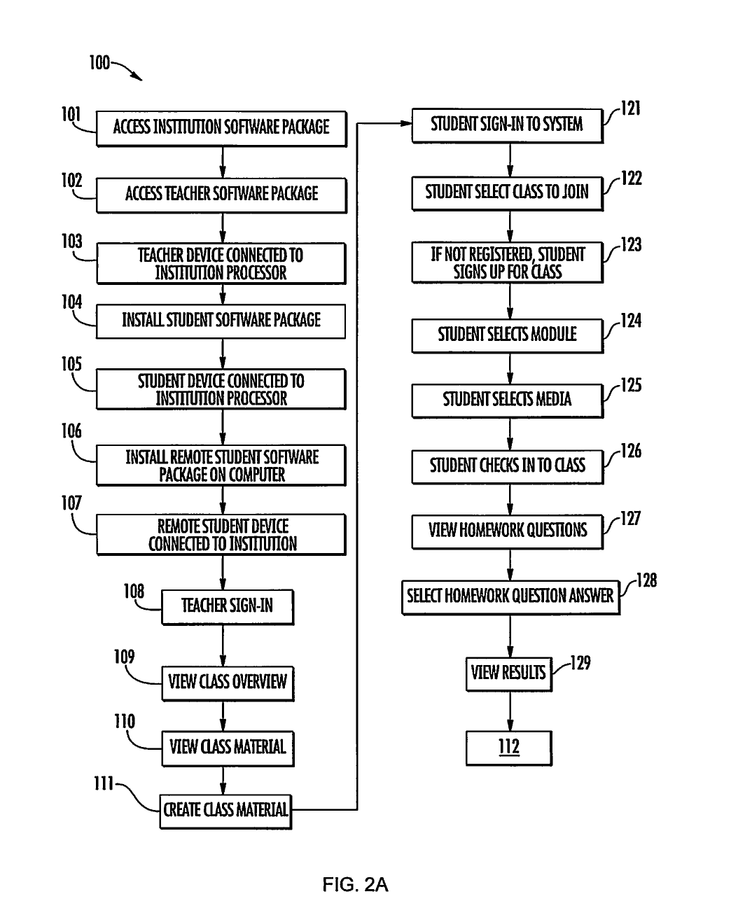

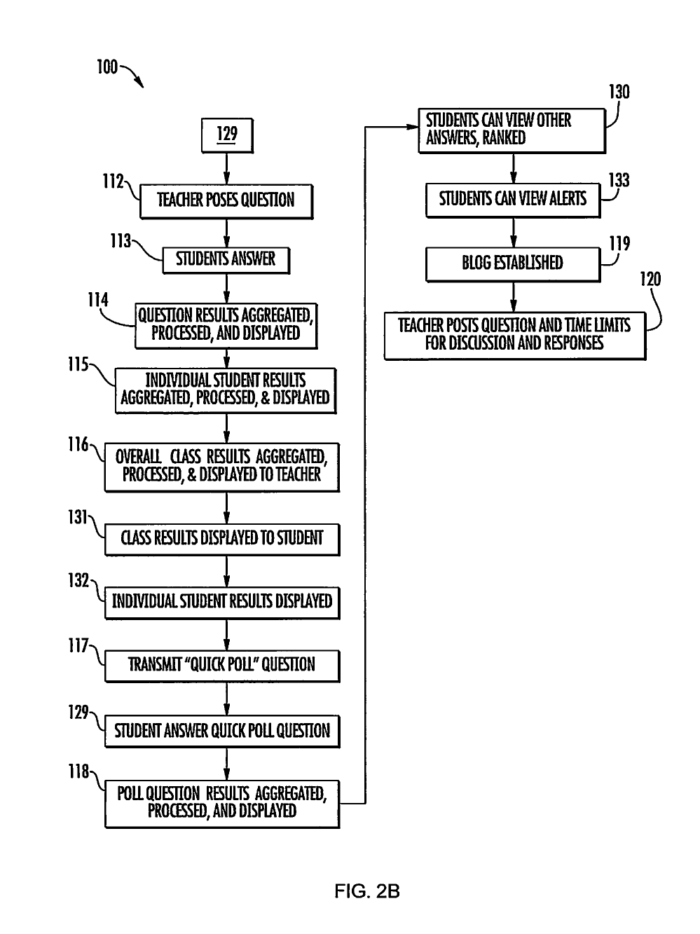

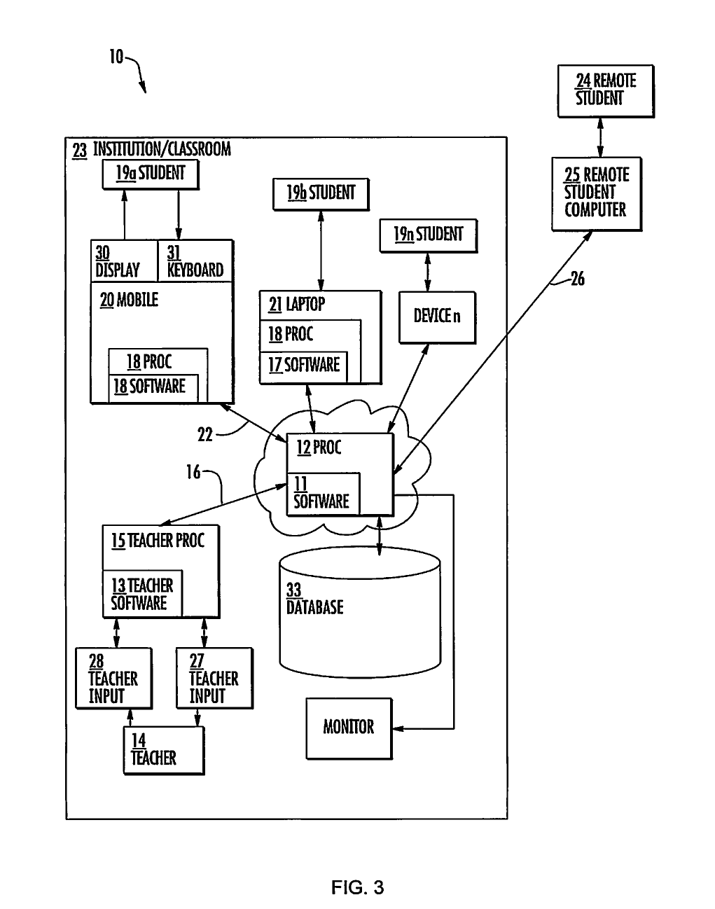

With continued reference to FIG. 1A and now to FIGS. 2A, 2B and 3, one method according to the teachings of the present invention comprises 105 placing a member device 19 in signal communications with the processor 12 through a wireless connection such as an Internet connection or Intranet connection. The network software 11 is accessed by the presenter using a presenter device 14, wherein a display 27 is presented on the presenter device, herein described by way of example as being performed on client/server software. The member of the audience, such as a student, selected 122 a presentation session to join, as will be described in greater detail later in this disclosure. A question may then be administered 112 to a plurality of members in the audience through the presenter device 14. A screen may be opened 121 by at least a portion of the members of the audience on the member device 14, wherein each member is permitted to log in (either through a native application (one built with code resident on the mobile device or through a web based application) 245, and wherein a plurality of screens is available on the displays 30 as mediated by the presenter through the network software 11, such as is available through “cloud computing.” As is known by those of skill in the art, cloud computing includes a delivery of computing (platform) as a service rather than a product, whereby shared resources, software, and information are provided to computers and other devices as a metered service over a network, typically the Internet.

By way of example, reference will now be made to a teacher and a student. However, those of ordinary skill in the art will easily understand how the systems and methods herein presented are applicable in presentation environments other that for institutions, such as schools, and are useful at conferences, meetings, tradeshows, exhibitions, and the like. By way of example, systems and methods according to the teachings of the present invention, may be used in virtual events and with online schools and other systems through dynamic and asynchronous delivery. To one skilled in the art, the “physical” location becomes irrelevant to the “classroom.” There need not be a physical location for the meeting. All learning can happen from instructor laptops with students located in separate locations.

With reference again to FIGS. 2A and 2B, the method 100 herein presented by way of example will be directed to a method for establishing and using a classroom interaction and to a classroom interaction system 10, as illustrated with reference to FIG. 3. The method 100, which includes actions by teacher and student, comprises establishing an interaction system 10 for an educational institution by accessing software as a service through a network cloud 11, by way of example, in a browser or in a native application, for example, using a processor 12. Alternatively, the processor 12 may be an institution processor, and the method 100 may include installing an institution software package 11 on the institution processor 12. See block 101 in the flow chart for the method 100, herein described by way of example. With continued references to FIG. 3, a teacher software package 13 may also be accessed (see block 102) by a teacher device 14, which typically comprises a computer 15, although this is not intended as a limitation. By way of example, C#, Objective C, HTML5 or a Java™ application can be installed on the computer 15 presenting the information for accommodating legacy clicker systems that utilize hardware in the classroom 23. The teacher device 14 is placed (see block 103) in signal communication with the institution processor 12 via, for example, an intranet or Internet connection 16.

As will come to the mind of those skilled in the art and now having the benefit of the teachings of the present invention, the teacher and student devices 14, 19 may include similar hardware.

With continued reference to FIG. 3, a student software package 17 is also installed on a processor 18 of a plurality of students 19a, 19b, . . . 19n devices (see block 104), which typically comprise at least one of a handheld device such as a mobile phone 20 or a laptop computer 21. The student devices 20, 21 are able to be placed (see block 104) in signal, typically wireless, communication 22 with the institution processor 12, or any HTTP or HTTPS application traffic over wired or wireless connections, although these are not intended as limitations. These students 19a, 19b, . . . 19n are be positioned in a classroom or virtually 23 when interacting with the system 10. As will be appreciated by those skilled in the art, now having the benefit of the teachings of the present invention, students may be in a real classroom, a remote classroom, a virtual classroom, as may also be the presenter. For the example herein described by way of example, the student software package 17 can also be installed on a remote student 24 device (block 106) that could also comprise, for example, a computer 25. The remote student device 25 is placeable in signal, typically Internet, communication 26 with the institution processor 12 (see block 107). Connection may be through a web browser as an alternate connection via a native application.

The teacher device 14 has a display 27 and an input, typically a keyboard 28, both in signal communication with the institution processor 12 via the teacher processor 15, but the teacher device may be connected via HTTP or HTTPS from any location such as their home, although this is not intended to be a limitation. Each of the student devices 20, 21, 25 has a display 30 and an input, typically a keyboard 31, both in signal communication via the student device processor 18 with the institution processor 12, wherein the institution processor may be an institution cloud processor.

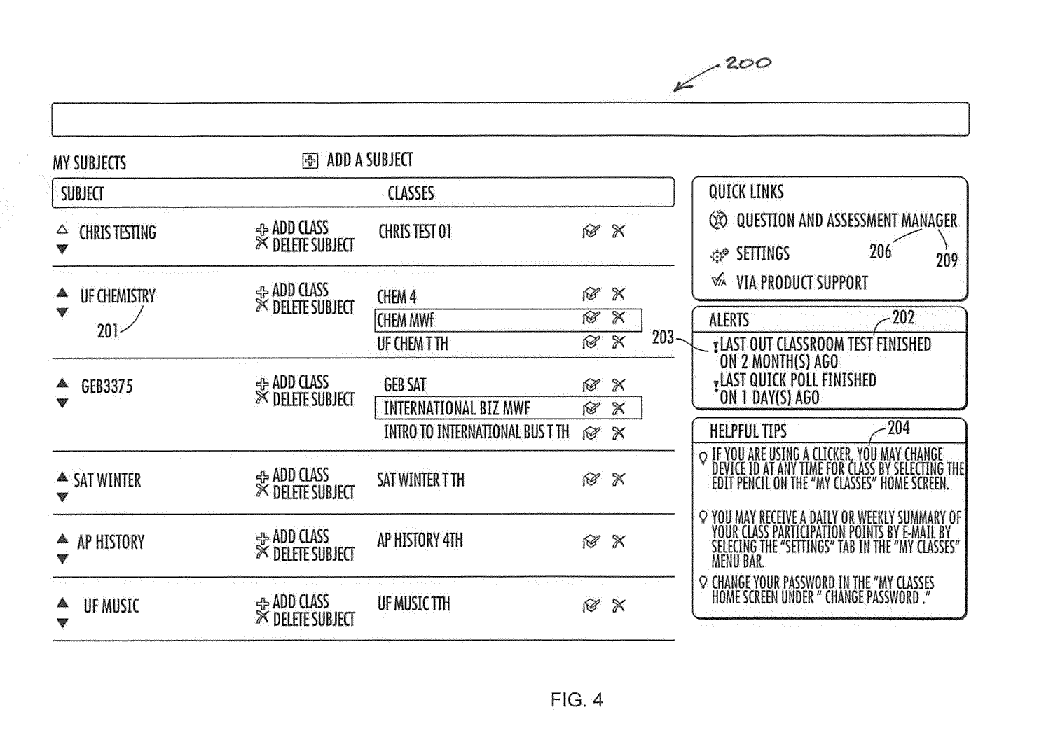

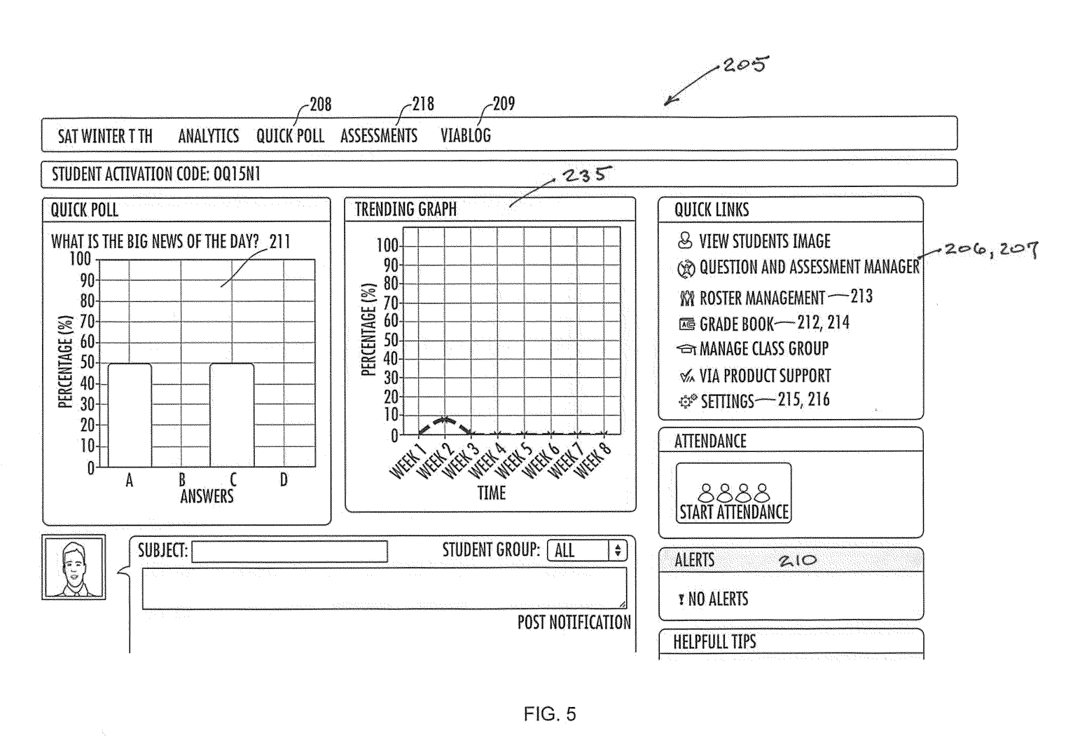

A teacher, through use of the teacher device 14 can view on the display 27 a plurality of screens as mediated by the teacher software package 13. Exemplary screens are illustrated in FIGS. 4 and 5, the functions of which will be discussed in the following description.

The teacher launches a plurality of screens with independent but symbiotic functionality as mediated by the teacher and the devices utilizes as well as the software package. Unlike typical applications well known in the art, an embodiment of the present invention has a single view of assessments and response shared by the students and the teachers. Exemplary screens with independent views allow the teacher to see all real time data rolled up and at a personally identifiable student level. A single data view solution, well known the art, is prohibited by law and may be governed by Family Education Rights and Privacy Act (FERPA). The present invention allows for dynamic peer to peer activities that are monitored by the teacher. The teacher knows which students are proficient learners and those individual students that need remediation. By way of example, the teacher could show questions from a lectern computer and review real-time assessments on a tablet device.

With continued reference to FIGS. 2A and 2B, after signing in (see block 108), a teacher 14 can view an opening page 200, as illustrated with reference to FIG. 4, that lists a schedule of all of his/her classes 201 that are enabled to work with the instant system 10. A list of alerts 202 is also displayed, including the status of blogs (to be discussed later in this disclosure) and pending action items such as quizzes ready for review 203. A help section 204 is also displayed to assist the teacher in navigating the teacher software 13. The teacher device 14, illustrated with reference again to FIG. 1A by way of example, can also send out invitations to join the class and set up class identification (ID) codes for registration purposes. The codes are then passed through a URL string to greatly simplify the registration code, an improvement over well know methods.

With reference again to FIG. 5, a Messaging Council including Discussions, Alerts, and Notifications are addressed, and herein referred to as Com-Link™. This sub-application allows for dynamic (live) as well as asynchronous class discussion. The instructor may organize subjects and drives the topics instead of an open non-structured discussion. Such a the tool is course and section specific so that groups do not have to “friend” or follow in more broadly defined tools.

By way of example, one application may comprise a Discussion which includes a board which drives a “big” idea in and out of the classroom. During class, the instructor may have a grad student monitoring the board. Students post either to the public board with public disclosure of who they are or post as a private comment to the instructor. The instructor selects the topic of each thread discussion and students can see all posts. This Com-Link™ allows for interaction to be instructor driven with an in-line student response, or enable a two-way interaction where students can comment on another student's posting in line. Students have the ability to set the types of alerts they get for each type of Com-Link™ activity (outside social media, text, e-mail) so they will always be informed. Private communication is set off in a different color for students. On the student portal side, the different threads have thematic coloring as well for identifying the type of communication occurring and if it is private or public. Class groups that have been defined for class projects can be selected and sent private messaging. The instructor may also enable a feature that dynamically builds word clouds through a keyword search to weight the most common words or phrases around a particular topic or period of time for class discussion purposes.

Further, a Notification may be provided that includes General Announcements about the class, upcoming assignments and activities for the week, and the like. This tool is two-way private/public. Icons in the thread indicate that this is a notification. This notification may also be displayed on a class home screen during a next starting period, by way of example, and as illustrated with reference again to FIG. 1A.

Alerts may indicate that “something” has changed and the instructor needs to get the word out to everyone quickly, a one-way communication.

Overall control by default shows all discussions inline and are color-coded. A drop down control allows instructors to isolate discussions by class discussion, group, alerts, notifications and private.

A Manage Class Groups Link allows instructors to build groups to receive private group assignments and drive discussions from the Com-Link™ messaging council. This provides easy in-line communication for the instructor. These messages are color coded.

With reference to FIG. 1B, Personalization of Communication is illustrated, by way of example. Current art has no student self-service. Students are typically tied to a hardware ID. In contrast, embodiments of the invention provide a complete profile and modality management through web-based tools, which provide access and self-service capabilities to dramatically simplify administration.

As a result, there were several desirable and unexpected consequences. By way of example, consider that students now have modality independence and can add/change input devices (and more than one is supported simultaneously). The online account is the arbiter and allows for self-service as the student is tied to the class at the portal level through authentication instead of a hardware driven ID.

Further, a software routing mechanism allows instructors to communicate through the platform once and allows the student to opt in and automatically receive communications, and further to respond back to requests through the messaging modalities of their choice. By way of example, a student may prefer Facebook or personal e-mail or might want certain types of communication to come by text.

A student portal allows students to see where they stand in the class at any time through an online portal that automatically posts completed assessments, again using “software as a service” techniques. Typically, current art is manual and requires instructors to build and e-mail assessment results.

With reference again to FIG. 4, selecting one of the classes 201 brings up a class overview page 205, as illustrated with reference to FIG. 5 (see also block 109 of FIG. 2A), which contains links for assessment management 206, importing questions 207, and creating a quick poll 208. Blog commands 209 are also presented, as well as class-specific alerts 210. A visual display, such as a pie chart or bar chart 211, graphically displays class average data 212. This page overview page 205 also permits the teacher 14 to manage a class roster 213, interact with a class grade book 214, post student notifications 215, and adjust settings 216.

By way of example, selecting the assessment management link 206 brings up a screen for viewing class material (see block 110) and selecting assessments 218 to create future assessments. The teacher can view homework and past assessments, and see which assessments may be incomplete, by way of example.

Selecting a link to create new assessments brings up a question creation screen, for inputting different types of questions or import questions from a database 33, where the instructor's computer may be in signal communication with the institution processor 12, but is not a limitation to the technology herein presented (see also block 111 of FIG. 2A). The questions can be used in tests or homework assignments. Timers can also be added for quizzes and tests, either as a whole or by individual question, and due dates for homework assignments set. Further, questions can be assigned a weighting factor to determine how much that question will count in an overall grade.

The Question and Assessment Manager 206, addressed earlier with reference to FIG. 4, is created to provide for global capabilities that function with the assessment engine and extend beyond class semesters. Like platform components of the present invention, the cloud based architecture allows for innovations over existing art in response and assessment. The application is broken down into three major database components (questions, assessment, and performance by question and by assessment) that provide for advanced management of questions and assessments.

Questions are the “DNA” or most elemental portions of the database design, and assessments and performance characteristics are an abstraction of the question elements. The Question and Assessment manager is found on the instructor's global home screen. One problem with existing art is that questions do not extend beyond the class period, and there is no way to share, exchange or improve on questions or see performance characteristics.

Question Components may include a source having Questions imported from other question banks and tagged with source information, which may be copyrighted material. The bank utilizes a question type interface (QTI), an open import/export tool for those familiar with the art, and instructors can keep or exclude individual questions based on their rigor and other characteristics that uniquely fit their needs. Instructors are no longer tied to proprietary question banks from textbook publishers.

The system question tool allows instructors to import questions from Excel™ spreadsheets for instructors that have created their own questions and types from past classes, by way of example. By way of example, a system may include a PowerPoint™ and Keynote plugin, utilizing available Application Programming Interfaces (API's) and custom coding, bridges questions created in Microsoft PowerPoint™ lectures to post automatically into Cloud based Question Manager for future use. An Integrated question creation tool allows instructors to create their own questions in multiple formats for use in their classroom and to share with others.

A Span of Use may include Individual, wherein Instructors may keep their questions solely tied to their user name and password, or Group, wherein Instructors or administrators may open up question(s) to other instructors within the same e-mail domain, which allows those instructors within that group to reuse the question objects from the shared bank. It may further include a Barter, wherein a barter/exchange also allows for an open market where instructors may offer their peer-reviewed questions in exchange for other quality questions with points to expand their question library. It may include a Sale, wherein Instructors may also sell their questions on a market for other instructors use. It may be Open, wherein unlimited use may be allowed with creative common use for questions they have authored. Yet further, it may be a combination thereof.

Another feature includes Tagging, wherein Questions carry tags to identify topic and learning objectives and can be pooled as such. Providing learning objectives to a pool of questions allows interchangeability of questions allowing instructors to build dynamic database driven assessments. An algorithm interchanges the questions tied to the SLO and is a powerful invention over prior art. For example, there may be 10 questions that essentially assess the same elemental learning outcomes. The questions can are different but can be interchanged dynamically in assessments.

A Performance feature includes a question carrying with it all historical performance and source information. By way of example, Instructors know a question source, question type, where it was used, and performance of students over time. If allowed by the instructors/author, the questions are opened up to allow for quality rankings by use of Likert scales from peer and students. Questions tagged with performance characterizes are an improvement over prior art.

In a Search feature, the Question Manager utilizes a search mechanism to find questions through multiple selects as defined by tagging, type, performance and keywords.

In an Assessment feature, Assessments are an abstraction layer above the questions and capable of utilizing all question types from the question bank. Assessments can take on their own performance characteristics as a group of questions. Via has organized question creation and delivery into a wizard for ease of use.

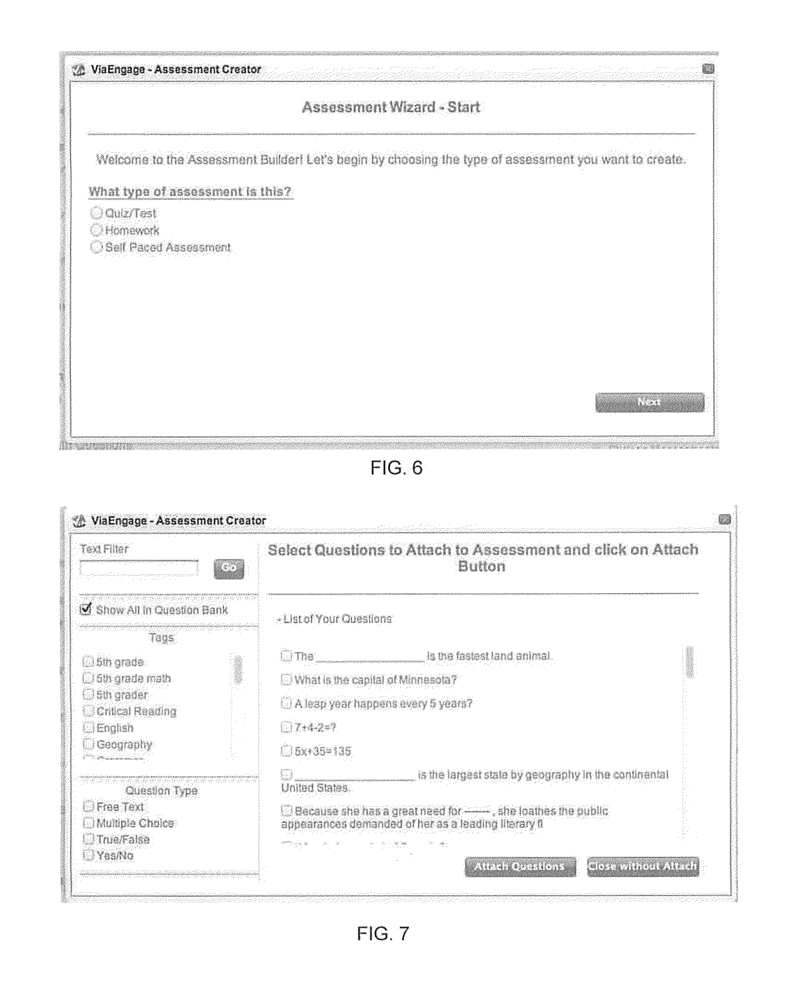

With reference to FIG. 1C illustrating a management layer of the system, a Question Wizard is deployed. The question wizard creates logical and clear paths for assessment creation to break down the complexity of building an assessment. The platform spans in classroom hardware as well as many different mobile devices. The wizard immediately establishes the type of assessment the instructors are building and automatically establishes the correct sub-set of the question pool. The wizard will immediately establish assessment type, which includes self-paced assessments, homework, single question polls, blogs, and in classroom quizzes although not intended to be a limitation. Reference is made to FIG. 6, by way of example of one screen shot used in this process.

Once the appropriate pool of available questions are established, the tool provides branching logic to allow: a) the instructor to select multiple questions from the question bank with all of the question types like: multiple choice, free response, t/f, matching, select all the apply and more or b) adding/creating individual questions that match the type of question being created, as illustrated with reference to FIG. 7.

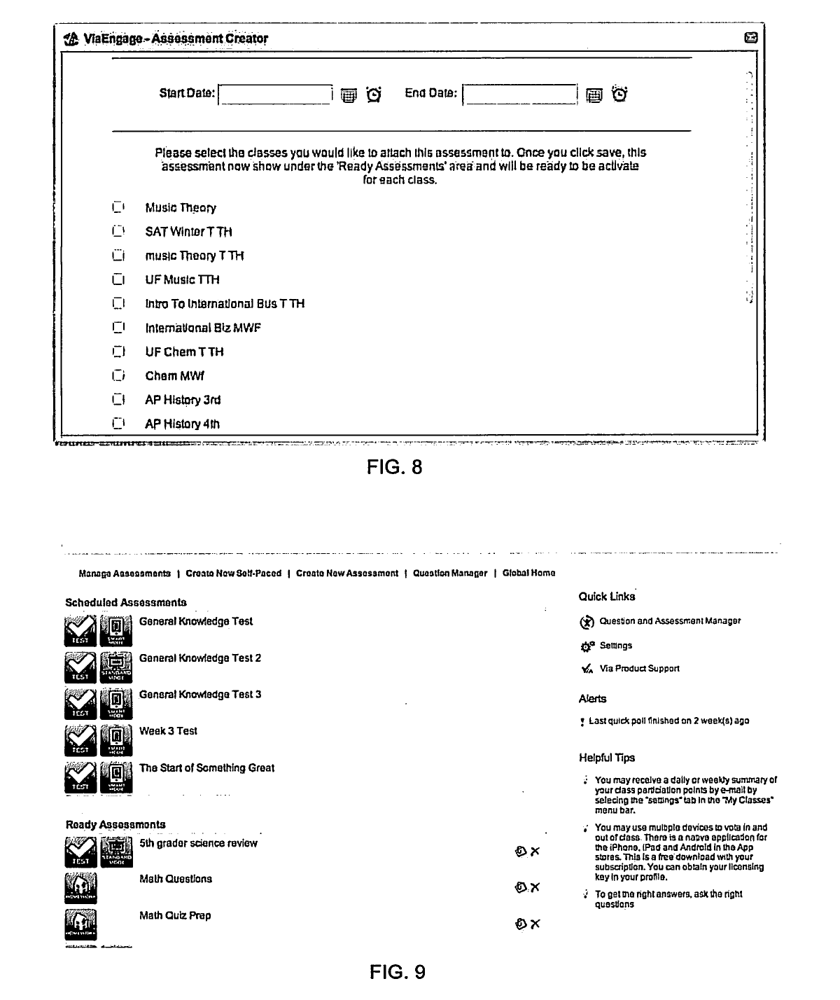

Once the wizard has guided the instructor through the assessment build process, it allows the instructor to assign the classes of choice, as illustrated with reference to FIG. 8.

The wizard offers a check box for an auto-scrambling ability by question (i.e. question 1 becomes question 5) and answers per student (i.e. B become D) while maintaining a backend key. Another checkbox allows question substitution if tags are assigned at the learning outcome level making question interchangeable within assessments. Assessments in the global question and assessment manager (QAM) live beyond the assigned period and are available to edit with question substitutions and ultimately reused. One-click functionality allows existing assessment to be assigned to a course and section.

With regard to a performance feature, as in the question manager, the assessment manager carries performance characteristics of the assessments indicating when the assessment was given and how well the students of prior classes performed.

As illustrated with reference to FIG. 9 regarding an Assessment Launch, once assessments are assigned they are located in a class section. They are identified by assessment type and mode of delivery. A Smart mode excludes input devices that do not allow free response input. Some assessments allow for instructors to monitor the student's progress dynamically to see how students are progressing through the exam.

In an Administration feature, a Question Assessment Manager (QAM) function allows for group administration through a special login. The group is defined by an e-mail domain and allows the administrator to build questions and assessments that can be defined to many instructors and sections. This allows for standards based testing and gives administrators the ability to easily define student-learning objectives to overarching campus goals.

Blind Surveys may be made through an Administration Mode. This functionality allows an administrator to place an assessment in course sections or in a consumer-testing environment that obviates student identity to the instructor. This is particularly helpful for student evaluations of their instructors. When enabled, the presentation or mobile screens clearly show that the assessment is in anonymous screening mode.

A Proctored Testing Control module of the present invention allows participants, such as students, to take a high stakes test from a remote location through a computer algorithm that generates a code for the instructor that they can forward to a qualified proctor. This code opens the assessment on the student's device for the proctored exam. This is extremely helpful for testing who serves in the military abroad but it is not intended to be a limitation.

With reference again to FIG. 2B, as a question is administered (see block 112) and the results received (see block 113) aggregated, various types of analytics are dynamically calculated and displayed for class results (see block 114), such as in vertical bar-graph format, pie-chart format, horizontal bar-graph format, “gas-gauge” format, or in curve format including a smoothed, slidable curve, although these are not intended as limitations. An indicator of a student learning objective can also be displayed against which the analytics can be compared. Individual student results can also be transmitted (see block 115 of FIG. 2B), which will be further described below.

As will come to the mind of those skilled in the art, now having benefit of the teachings of the present invention, class averages can also be displayed in graph format 235 (see also block 116 of FIG. 2B and FIG. 5), indicating, for example, a time line of tests and quizzes. Data is now available in the cloud processor 11 and can be reviewed anywhere and at any time as permitted by the presenter, by way of example using a browser, and can be rolled up to a data storage 33 for review of longitudinal data across classes, instructors, institutions and regions. Furthermore, data is now able to be compared against a student learning objective longitudinally and down to an individual student as defined by the teacher, by way of example.

Interest can be maintained during class by transmitting a “quick poll” question (see block 117 of FIG. 2B), the results of which can be aggregated, processed, and displayed in, for example, bar-graph form (see block 118 of FIG. 2B) or pie-chart form, and can also display a list of those students who have participated. A timer can also be set for submitting a quick poll response.

Using the teacher device 14, a teacher can elect to establish a class blog specific to a class (see block 119 of FIG. 2B), for which questions can be posted and time limits for discussions and responses (see block 120 of FIG. 2B).

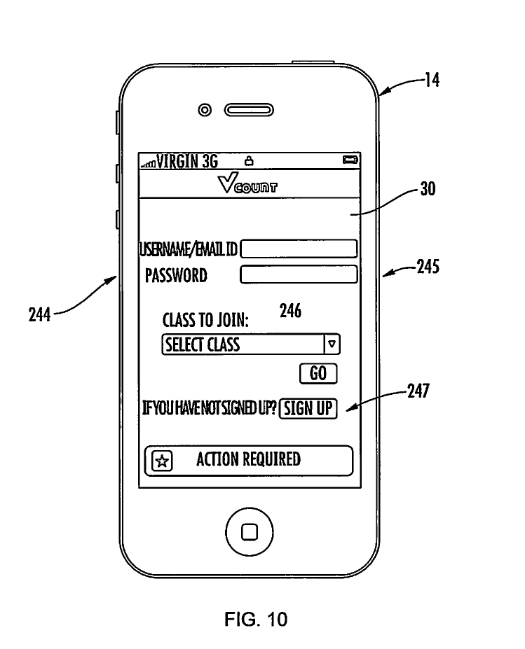

With reference again to FIGS. 1 and 4, and now to FIG. 6 the student devices 19a, 19b, . . . 19n, 24 can include a plurality of screens on their displays 30 as mediated by the student software package 17. An exemplary screen is illustrated in FIG. 10 illustrating an exemplary student login interface and screen shot. Screen shots may include selecting from available modules in a particular class, selecting from among media available for a particular class, displaying attendance records and checking in to a class, performing a homework assignment, multi question quizzes, answering a poll question and displaying correctness of the answer and class results, viewing answers submitted by students in a class and ranked by some criterion, displaying grade distributions for a class, displaying grade distributions based upon factors determining the grade, viewing a student's own grade results for the class, displaying student and teacher notifications, and the like.

As illustrated with reference again to FIGS. 1A, 4, 5 and 10, the instructor login allows instructors to have all data cloud based instead of on an individual hard drive.

As illustrated with reference again to 2B, a student opening screen 244 permits the student device 19a, 19b, . . . 19n, 24 to log in 245 (see block 121 in FIG. 2B), select which class to join 246 (see block 122 of FIG. 2B), and, if not already signed up, sign up for the class 247 (see block 123 of FIG. 2B).

As may be displayed on alternate screens, a class opening page permits the student devices 19a, 19b, . . . 19n, 24 to select a module to access. See block 124 of FIG. 2B. As illustrated with reference again to FIG. 1A, a plurality of media may also be offered (see block 125 of FIG. 2B) for the class. The present invention includes a login to the cloud processor 11. Therefore, the “many-to-many” architecture is available and not simply the “many-to-one” as required in typical systems.

By way of example, an attendance module displays the student's attendance record and permits the student to check in for full participation (see block 126 of FIG. 2A), for example, by entering a password. Alternatively, a bar code may be provided that would be read for class sign-in, or GPS could be used to check in for a class. A homework module displays homework questions (see block 127 of FIG. 2A) with, for example, multiple-choice answers among which the student through the student device 19a, 19b, . . . 19n, 24 can select one (see block 128 of FIG. 2A). As will be understood, questions available using embodiments of et present invention may include true and false, yes and no, fill in the blank, matching, any creative question formulated by the teacher.

A quick poll module, which will typically have a finite response time permitted, displays a poll question, correctness of answer, and overall class results (see block 129 of FIG. 2A). The student devices 19a, 19b, . . . 19n, 24 can also view other students' answers (with student anonymity preserved), presented in some rank order, for example, by those deemed to be the best responses, and can include comments by the teacher 14 or other student devices 19a, 19b, . . . 19n, 24 (see block 130 of FIG. 2B).

Overall class grades can be viewed by the student devices 19a, 19b, . . . 19n, 24 (see block 131 of FIG. 2B) as a pie chart, for example, or as a numerical list. The students through use of the student devices 19a, 19b, . . . 19n, 24 can also access his/her own grades (see block 132 of FIG. 2B). The student devices 19a, 19b, . . . 19n, 24 can have the option, for example, by clicking on one of the percentages 262, to view his/her raw totals and assessments for review.

The student devices 19a, 19b, . . . 19n, 24 can also access alerts (see block 133 of FIG. 2B), such as assignment alerts and teacher notifications. Further, such alerts and other communications can be personalized and “pushed” to an individual student, thereby maintaining some level of secrecy in that communication.

The system and methods herein described for the present invention provide a desired “mobility” as will be clear to those of ordinary skill in the art now having the benefit of the teachings of the present invention, and an understanding of the presentation mode illustrated and herein described with reference to FIG. 1A.

Further, desirable Anti-Cheating mechanisms are provided for smart devices. This is accomplished by monitoring the student through API's available from the device OS (Android and iPhone, by way of example). An application of the present invention includes built functionality to ascertain if the student is leaving the assessment. If detected, the mobile application sends an alert to the server. Instructor sets automatic thresholds globally or by assessment to programmatically alert the instructor to the prohibited activity.

The present invention provides Application Persistence and Mobile Data Storage. Current art utilizes applications that do not store data, which presents workflow interruption for assessment. Embodiments of the invention introduce a “lightweight” database and data caching to allow students to continue to work with sporadic wireless network connections. Extensible markup Language (XML) caching is utilized to further provide device autonomy and continuity during brief network outages. Using an algorithm, the application determines signal strength and throughput and determines how much of an assessment to pull down at a time. The application will check for connection to post data back to the server but the mobile device holds data and continues to poll for connection and send data as soon as connectivity is available again. This solves the problem of transient connectivity in the classroom and out of the classroom.

As illustrated with reference to FIG. 1C, LMS Integration is provided. Current art utilizes a client server application and instructor interface to manually kick off XML based data to pull in roster data and export grade data. This is less than optimal solution and requires constant instructor intervention. Because of the web based architecture of embodiments of the present invention, Learning Tool Interoperability (LTI), an open protocol established by IMS, may be utilized as well as a dynamic set of web services are instantiated enabling: 1) Validation of the identity of the instructor for one-time authentication; 2) Automatic downloads of roster information for school data repositories; 3) Update and change roster dynamically via web methods; and 4) Delivery of student performance and testing data automatically to school data repositories.

It can be seen that the present system 10 and method 100 satisfy a long-felt need in group communications, especially class communications, serving to maintain student interest and attention, and thereby fostering better learning, as well as providing a valuable real-time tool for teachers to ascertain how well material is being absorbed by the students. Remote students are drawn into the class more effectively, thereby also increasing their sense of participation and absorption of material.

By way of further example, embodiments may use a PAAS (platform as a service) provider which is a launching point for a PAAS platform for assessment being delivered with load balancing, caching and geo-distribution. Further, embodiments of the invention provide a desirable extension to current art is that synchronous and asynchronous assessment may be combined on a single platform, a desirable feature in 21st Century classroom learning.

Flowcharts and block diagrams herein described illustrate architecture, functionality, and operation of possible implementations of systems, methods and computer program products according to various embodiments. Therefore, it will be understood by those of skill in the art that each block in the flowchart or block diagram may represent a module, segment, or portion of code, which comprises one or more executable computer program instructions for implementing the specified logical function or functions. Further, some implementations may include the functions in the blocks occurring out of an order herein presented. By way of non-limiting example, two blocks shown in succession may be executed substantially concurrently, or the blocks may at times be executed in the reverse order, depending upon the functionality involved. It will also be noted that each block of the block diagrams and flowcharts, and combinations of blocks in the block diagram and flowchart illustrations, may be implemented by special purpose hardware-based systems that perform the specified functions or acts, or combinations of special purpose hardware and computer instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Aspects of various embodiments may be embodied as a system, method or computer program product, and accordingly may take the form of an entirely hardware embodiment, an entirely software embodiment (including firmware, resident software, micro-code, and the like) or an embodiment combining software and hardware aspects that may all generally be referred to herein as a system. Furthermore, aspects of various embodiments may take the form of a computer program product embodied in one or more computer readable media having computer readable program code embodied thereon. It is understood that the computer implemented method herein described operates with readable media relating to non-transitory media, wherein the non-transitory computer-readable media comprise all computer-readable media, with the sole exception being a transitory, propagating signal.

Any combination of one or more computer readable media may be utilized. A computer readable medium may be a computer readable signal medium or a computer readable storage medium. A computer readable storage medium may be, by way of non-limiting example, an electronic, magnetic, optical, electromagnetic, infrared, or semiconductor system, apparatus, or device, or any suitable combination of the foregoing. More specific non-limiting examples of the computer readable storage medium may include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, by way of non-limiting example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and the like, or any suitable combination thereof. Computer program code for carrying out operations for aspects of various embodiments may be written in any combination of one or more programming languages, including an object oriented programming language such as Java, Smalltalk, C++ or the like and conventional procedural programming languages, such as the C programming language or similar programming languages. The program code may also be written in a specialized language. The program code may execute entirely on the user's computer, partly on the user's computer, as a stand-alone software package, partly on the user's computer and partly on a remote computer, or entirely on the remote computer or server. The remote computer may be connected to the user's computer through any type of network, including a local area network (LAN) or a wide area network (WAN), or the connection may be made to an external computer (by way of non-limiting example, through the Internet using an Internet Service Provider).

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included with the scope of the appended claims.

That which is claimed:

1. A computer implemented method for providing information to members of an audience by a provider while allowing interaction between the members of the audience and the presenter, the computer implemented method comprising:
accessing network software as a service in a browser operable with a processor, placing member devices in signal communications with the processor through at least one of an Internet connection and an Intranet connection;
accessing the network software by the presenter using a presenter device;
presenting information to the members in the audience; and
communicating with the presenter device by at least a portion of the members using the member devices.
